(19) United States
(12) Patent Application Publication
(10) Pub. No.: US 2007/0210468 A1
(43) Pub. Date: Sep. 13, 2007

(54) MANUFACTURING METHOD OF A SEMICONDUCTOR DEVICE

(76) Inventor: Kiyoshi TSUCHIDA, Nanae (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/626,455

(22) Filed: Jan. 24, 2007

(30) Foreign Application Priority Data
Mar. 9, 2006 (JP) 2006-63954

(51) Int. Cl. B29C 33/72; B29C 70/34

(52) U.S. Cl. 264/39; 264/257

(57) ABSTRACT

Mask sheets, a cleaning sheet and rubbery cleaning resin bars are disposed on a lower mold of a molding die and thereafter the molding die is clamped, allowing the interior of a cavity to be filled with cleaning resin to clean the molding die, whereby even portions into which resin is difficult to enter with only the injection pressure from pots can be filled with the cleaning resin. Consequently, cleaning of the molding die can be effected without being influenced by the resin injection pressure in transfer molding and it is possible to improve the cleanability of the molding die.

### CROSS-REFERENCE TO RELATED APPLICATION

The present application claims priority from Japanese patent application No. 2006-63954 filed on Mar. 9, 2006, the content of which is hereby incorporated by reference into this application.

### BACKGROUND OF THE INVENTION

The present invention relates to a semiconductor device manufacturing technique and particularly to a technique applicable effectively to the improvement of cleanability of a resin molding die.

There is known a technique wherein circuit components are mounted for each section on a components mounting surface as one surface of a matrix substrate formed of a mixture of ferrite powder and resin and the components mounting surface on one surface of the substrate is molded using a composite ferrite as a mixture of ferrite powder and resin to cover all the circuit components in each section (see, for example, Japanese Unexamined Patent Publication No. 2001-35867 (FIG. 1)).

There also is known a technique wherein a die regeneration sheet using unvulcanized rubber material as a base material is divided into an appropriate size from slit portions so as to match several types of transfer molding machines of different die sizes and the divided sheets are used for washing surfaces of upper and lower molds (see, for example, Japanese Unexamined Patent Publication No. Sho 63 (1988)-227308 (FIG. 6)).

### SUMMARY OF THE INVENTION

Recently, in the manufacture of BGA (Ball Grid Array) and CSP (Chip Size Package) type semiconductor devices, for example MAP (Mold Array Package) method has been adopted as a transfer molding technique of sealing plural semiconductor chips all together using resin. According to the MAP method, there is used a wiring substrate (a matrix substrate) having plural product-forming areas (device areas) partitioned by scribing lines and arranged planarly in a matrix shape and plural semiconductor chips mounted on a main surface of the wiring substrate correspondingly to the product-forming areas are resin-sealed by a single resin sealing body, then, the matrix substrate is divided along the scribing lines. Therefore, the number of products obtained can be increased in comparison with the individual molding method wherein one semiconductor chip is resin-sealed using one cavity (sealing cavity).

However, if the sealing body is formed by the MAP method, the wiring substrate is stressed and assumes a warped state. This is because a mold release material is contained in the sealing resin for the purpose of improving the releasability of the resin from the molding die and a contracting action is exerted on the sealing body under the influence of the mold release material. In the MAP method, moreover, the total amount of the sealing resin used is larger than in individual molding and this is another cause of the aforesaid phenomenon.

As shown in Japanese Unexamined Patent Publication No. 2001-35867 (FIG. 1), by forming the sealing body with use a resin molding die having stepped portions, it is possible to thin the resin at the portions corresponding to the scribing lines and hence possible to diminish a shrinkage stress induced in the sealing body.

However, the mold release agent as a component contained in the sealing resin and causing stain is fixed to a mold surface and is accumulated into an oxide and a dust particle, causing defective molding which affects the resulting product. Further, a wiring substrate is installed into a semiconductor device such as BGA (Ball Grid Array) or CSP (Chip Size Package) and an insulating film (solder resist film, protective film) formed on a surface of the wiring substrate is heated and pressurized at a high temperature of 170° to 180° C. under the influence of heat when forming the sealing body by resin molding, with consequent outgassing. Contamination after molding caused by the contamination component, impurity and product resin is shotted repeatedly and is thereby fixed to the intra-mold surface.

In view of this point, the resin molding die for molding resin into a sealing body for a semiconductor device is subjected, after molding plural times, to a cleaning work periodically using such cleaning resin as shown in Japanese Unexamined Patent Publication No. Sho 63 (1988)-227308 (FIG. 6), whereby the impurity and dust particle adhered to the intra-mold surface can be removed.

However, in the case where a large number of products are to be obtained at a time like MAP products, the area of a cavity in a resin molding die used becomes large and therefore a cleaning resin pouring (injecting) pressure is difficult to be applied around gates in comparison with a cavity end (a remotest position from gates within the cavity) from pots. This is not limited to MAP products. Also in a resin molding die for individual molding, as shown in FIGS. 28 and 29, the side where gates of a cavity are formed lie in a direction in which resin returns while lapping on from the gates, so that the cleaning resin injecting pressure becomes difficult to be applied to the gate-side end portion (edge portion). Moreover, in the case where stepped portions are formed in a resin molding die as in Japanese Unexamined Patent Publication No. 2001-35867 (FIG. 1), if the cleaning resin injecting pressure is low, it is difficult to reach the stepped portions (especially the gate-side end portion), with the result that the portion A shown in FIG. 29 is not filled with the cleaning resin, that is, the contamination of the impurity adhered to each stepped portion cannot be removed by cleaning.

Consequently, by such a cleaning method as in Japanese Unexamined Patent Publication No. Sho 63 (1988)-227308 (FIG. 6) involving mere injection of cleaning resin from pots, it is difficult to remove components which cause contamination such as impurity and mold release agent.

As a countermeasure to the problem of unloading in continuous resin molding there sometimes is a adopted a method wherein a resin molding die is made air-ventless, while air vents are formed in a lead frame. In this case, even if cleaning resin is injected along flow paths in the molding die, air becomes difficult to be discharged because air vents are not provided, thus giving rise to the risk that the cleaning of air vents becomes difficult.

Thus, in the molding die wherein cleaning resin is difficult to be injected into flow paths or a cavity, it becomes difficult to effect the injection of cleaning resin and hence there arises the problem that the cleaning of the molding die becomes insufficient.

By adopting a resin molding method using a laminate film it becomes possible to prevent the fixation of contamination with respect to the cavity portion. However, the shape of an upper mold is complicated because air vents and gates are formed in the upper mold. Therefore, if the whole of the mold surface is covered with a laminate film, the film is apt to be wrinkled particularly in the portions of air vents, gates and pots and thus it is difficult to dispose the laminate film. In the wrinkled state of the laminate film it is difficult to effect the injection of cleaning resin. Consequently, the gates and pot row portion, with laminate film not applied thereto, are required to go through a cleaning process including cleaning and mold release/recovery shots for removing thin resin burrs fixed around the pot row and contamination, e.g., oxide film and outgassing. Further, the use of a laminate film gives rise to the problem that the cost becomes high.

In Japanese Unexamined Patent Publication No. 2001-35867, there is found no description on the cleaning process for a resin molding die.

In Japanese Unexamined Patent Publication No. Sho 63 (1988)-227308 (FIG. 6), there is a description on cleaning resin used in the cleaning process for a resin molding die, but there is not found any detailed description about a cleaning method for portions difficult to be applied with the resin injecting pressure as in Japanese Unexamined Patent Publication No. 2001-35867 (FIG. 1).

It is an object of the present invention to provide a technique able to improve the cleanability of a resin molding die.

The above and other objects and novel features of the present invention will become apparent from the following description and the accompanying drawings.

The following is an outline of typical modes of the present invention as disclosed herein.

The present invention, in one aspect thereof, comprises disposing a molding die cleaning sheet onto a molding die correspondingly to a cavity of the molding die and a rubbery cleaning resin thereon, thereafter clamping the molding die cleaning sheet and the rubbery cleaning resin with the die, filling cleaning resin formed by the pressure of the clamping into the cavity, allowing the cleaning resin to be cured, and thereafter taking out the molding die cleaning sheet from the molding die.

The present invention, in another aspect thereof, comprises covering suction holes with a mask sheet, the suction holes being open in a mold surface of a molding die, disposing a molding die cleaning sheet onto the molding die correspondingly to a cavity and a rubbery cleaning resin thereon, clamping the molding die cleaning sheet and the rubbery cleaning resin with the molding die while closing the suction holes with the mask sheet, filling cleaning resin formed by the pressure of the clamping into the cavity, allowing the cleaning resin to cure, thereafter taking out the molding die cleaning sheet and the mask sheet from the molding die, and separating the molding die cleaning sheet and the mask sheet from each other.

The following is a brief description of effects obtained by the typical modes of the present invention as disclosed herein.

By disposing both molding die cleaning sheet and rubbery cleaning resin onto the molding die, then clamping the molding die and filling cleaning resin formed by the clamping into the cavity to clean the molding die, it is possible to clean the resin molding die without being influenced by variations in resin injection pressure and flow path in transfer molding and also possible to remove 50% or more of contamination in an initial shot (one cycle comprises filling arbitrary resin between molds and taking it out after curing) and thereby greatly improve the cleanability of the resin molding die.

MAP, CSP and BGA product substrates are apt to become contaminated and therefore the molding die cleaning frequency is set about 7.5 times higher than in the molding die cleaning frequency for a metallic product frame, e.g., 42 alloy, Cu, like 1500 shots/time vs. 200 shots/time.

In case of adopting a method of pouring cleaning resin from pots without using a rubbery cleaning resin, at least 8 shots are needed.

If there is adopted a method involving using a rubbery cleaning resin in an initial shot and subsequently pouring cleaning resin from pots, contamination can be removed efficiently by a total of about 3 shots from the first to the third shot. As a result, it is possible to improve the cleanability, shorten the time required for the cleaning work, reduce the amount of material used and ensure a high quality of product. Thus, the method in question is a highly effective molding die cleaning method extremely high in performance.

### BRIEF DESCRIPTION OF THE DRAWINGS

FIG. 1 is a perspective view showing an example of a state in which rubbery cleaning resin bars are disposed to a molding die in a semiconductor device manufacturing method according to a first embodiment of the present invention;

FIG. 2 is an enlarged partial sectional view showing a structural example after the disposition of the rubbery cleaning resin bars shown in FIG. 1;

FIG. 3 is a perspective view showing a structural example in a clamped state of the molding die in the semiconductor device manufacturing method of the first embodiment;

FIG. 4 is an enlarged partial sectional view showing a structural example in the clamped state of the molding die shown in FIG. 3;

FIG. 5 is a perspective view showing a structural example in an open condition of the molding die in the semiconductor device manufacturing method of the first embodiment;

FIG. 6 is a perspective view showing an example of mask sheets and a molding die cleaning sheet both taken out from the molding die which is in the open condition shown in FIG. 5;

FIG. 7 is an enlarged partial sectional view showing a structural example of the molding die cleaning sheet shown in FIG. 6 after cleaning;

FIG. 8 is a perspective view showing a state in which the mask sheets are disposed to the molding die in a semiconductor device manufacturing method according to a modification of the first embodiment;

FIG. 9 is a perspective view showing a state in which an integral type rubbery cleaning resin is disposed to the molding die shown in FIG. 8;

FIG. 10 is a translucent diagram showing a state in which the rubbery cleaning resin shown in FIG. 9 is disposed in a clamped state of the molding die;

FIG. 11 is a sectional view showing a structural example of a semiconductor device assembled by the semiconductor device manufacturing method of the first embodiment;

FIG. 12 is back view showing a structural example of the semiconductor device shown in FIG. 11;

FIG. 13 is a manufacturing process chart showing an example of procedure for assembling the semiconductor device shown in FIG. 11;

FIG. 14 is a sectional view showing the structure of a matrix substrate used in semiconductor device assembly according to a modification of the first embodiment;

FIG. 15 is a sectional view showing the structure after die bonding in the semiconductor device assembly according to the modification of the first embodiment;

FIG. 16 is a sectional view showing the structure after wire bonding in the semiconductor device assembly according to the modification of the first embodiment;

FIG. 17 is a sectional view showing the structure during resin molding in the semiconductor device assembly according to the modification of the first embodiment;

FIG. 18 is a sectional view showing the structure in mounting solder balls in the semiconductor device assembly according to the modification of the first embodiment;

FIG. 19 is a sectional view showing the structure in washing the solder balls in the semiconductor device assembly according to the modification of the first embodiment;

FIG. 20 is a sectional view showing the structure in individual dicing in the semiconductor device assembly according to the modification of the first embodiment;

FIG. 21 is a perspective view showing the structure of a semiconductor device according to the modification of the first embodiment;

FIG. 22 is a perspective view showing an example of a state in which rubbery cleaning resin bars are disposed to the molding die in a semiconductor device manufacturing method according to a second embodiment of the present invention;

FIG. 23 is an enlarged partial sectional view showing a structural example after the disposition of the rubbery cleaning resin bars shown in FIG. 22;

FIG. 24 is a perspective view showing a structural example in a clamped state of the molding die in the semiconductor device manufacturing method of the second embodiment;

FIG. 25 is an enlarged partial sectional view showing a structural example in the clamped state of the molding die shown in FIG. 24;

FIG. 26 is a perspective view showing a structural example in an open condition of the molding die in the semiconductor device manufacturing method of the second embodiment;

FIG. 27 is a perspective view showing an example of mask sheets and a molding die cleaning sheet both taken out from the molding die which is in the open condition shown in FIG. 26;

FIG. 28 is a plan view showing a state of a cleaning resin pouring pressure;

FIG. 29 is a partial enlarged view of FIG. 28; and

FIG. 30 is a plan view showing a state of diffusion of the cleaning resin.

### DETAILED DESCRIPTION OF PREFERRED EMBODIMENTS

In the following embodiments, as to the same or similar portions, repeated explanations thereof will be omitted in principle except where required.

Where required for convenience' sake, the following embodiments will each be described in a divided manner into plural sections or embodiments, but unless otherwise mentioned, they are not unrelated to each other but are in a relation such that one is a modification or a detailed or supplementary explanation of part or the whole of the other.

In the following embodiments, when reference is made to the number of elements (including the number, numerical value, quantity and range), no limitation is made to the number referred to, but numerals above and below the number referred to will do as well unless otherwise mentioned and except the case where it is basically evident that limitation is made to the number referred to.

Embodiments of the present invention will be described in detail hereinunder with reference to the accompanying drawings. In all of the drawings for illustrating the embodiments, members having the same functions are identified by the same reference numerals, and repeated explanations thereof will be omitted.

### First Embodiment

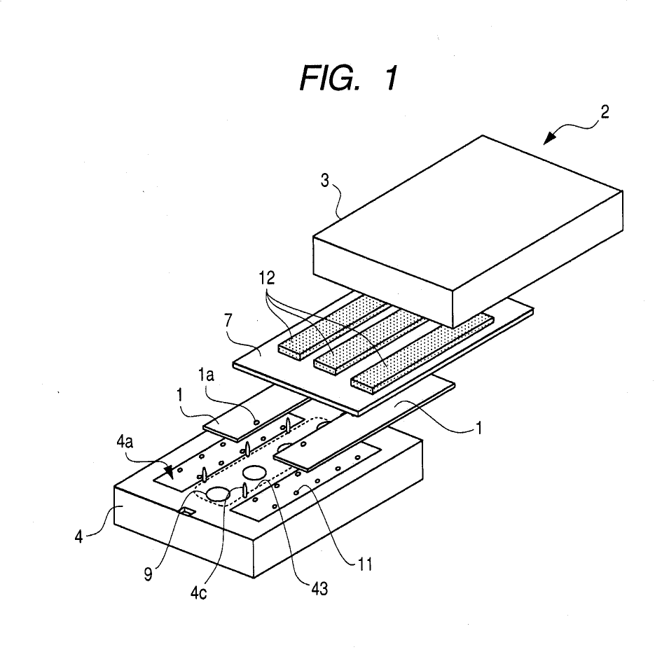

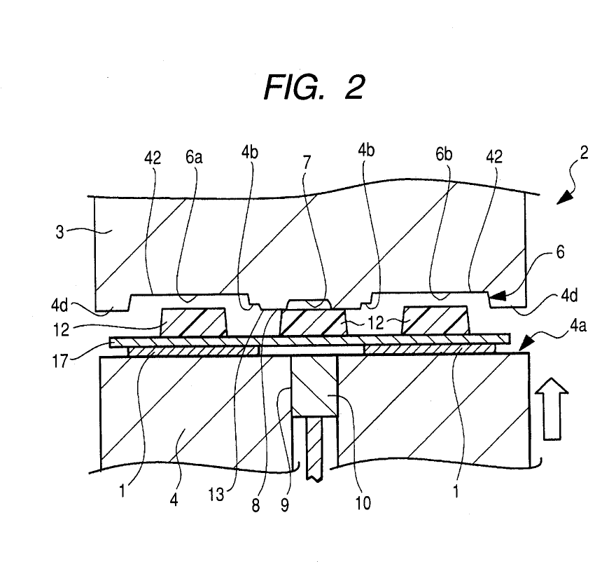

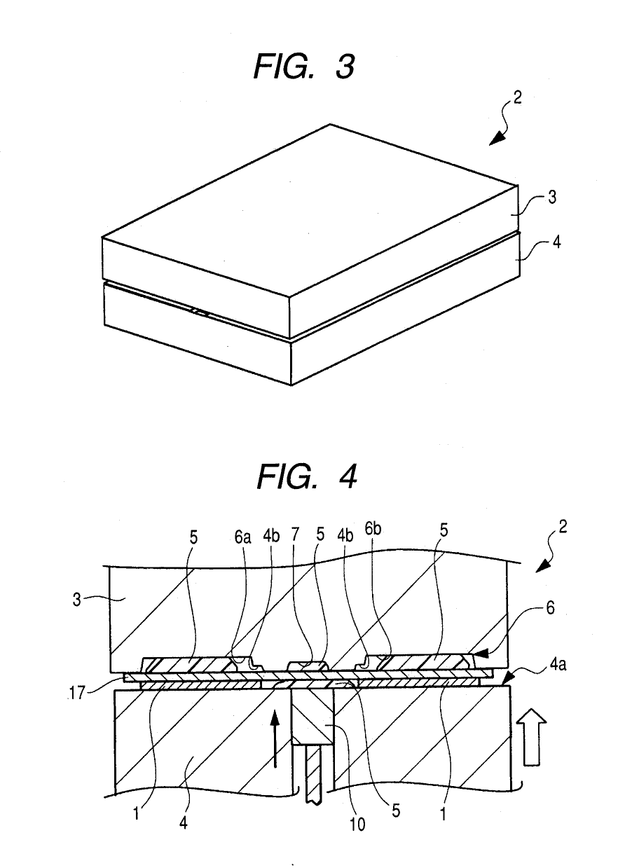

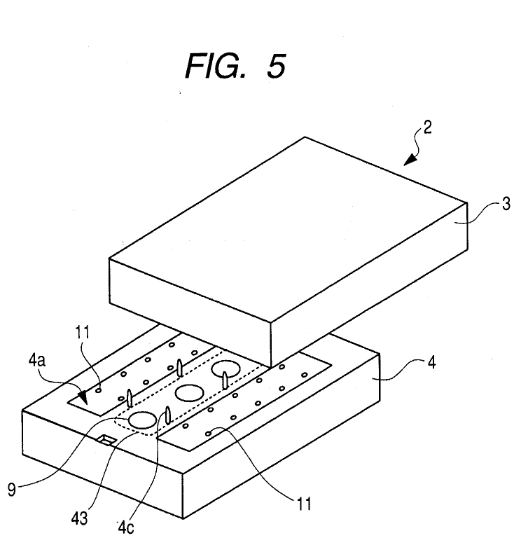

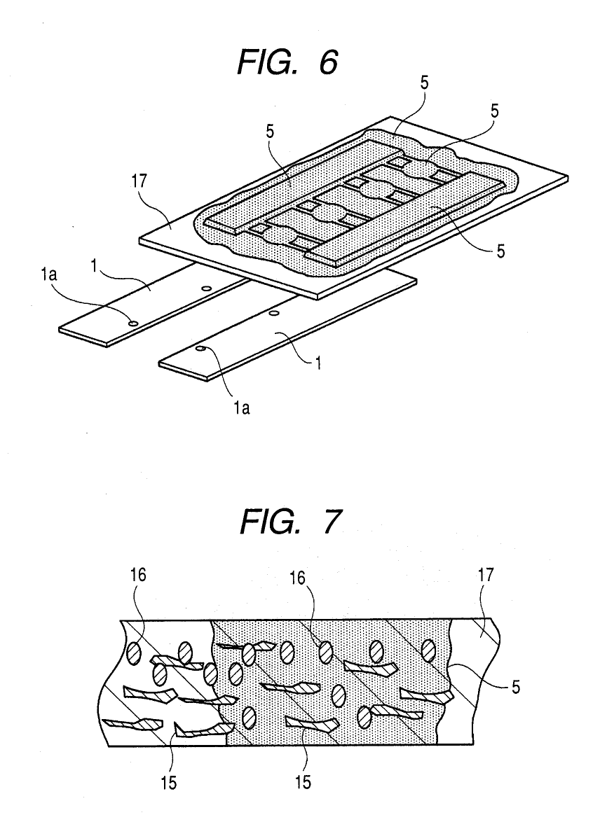

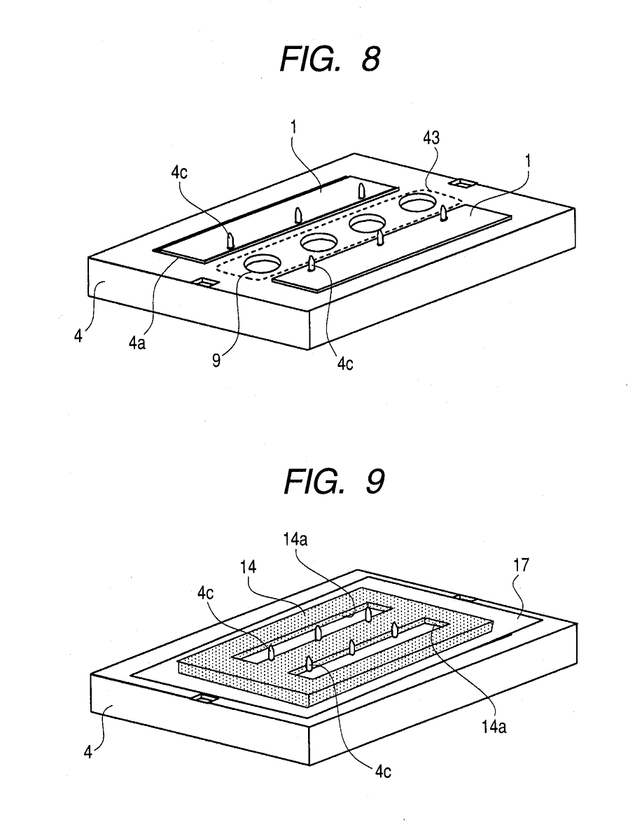

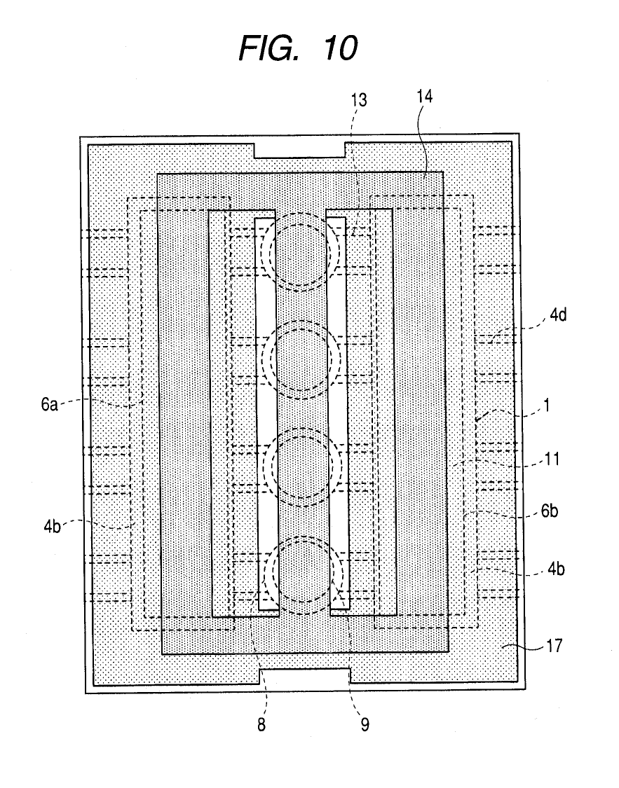

FIG. 1 is a perspective view showing an example of a state in which rubbery cleaning resin bars are disposed to a molding die in a semiconductor device manufacturing method according to a first embodiment of the present invention, FIG. 2 is an enlarged partial sectional view showing a structural example after the disposition of the rubbery cleaning resin bars shown in FIG. 1, FIG. 3 is a perspective view showing a structural example in a clamped state of the molding die in the semiconductor device manufacturing method of the first embodiment, FIG. 4 is an enlarged partial sectional view showing a structural example in the clamped state of the molding die shown in FIG. 3, FIG. 5 is a perspective view showing a structural example in an open condition of the molding die in the semiconductor device manufacturing method of the first embodiment, FIG. 6 is a perspective view showing an example of mask sheets and a molding die cleaning sheet both taken out from the molding die which is in the open condition shown in FIG. 5, FIG. 7 is an enlarged partial sectional view showing a structural example of the molding die cleaning sheet shown in FIG. 6 after cleaning, FIG. 8 is a perspective view showing a state in which the mask sheets are disposed to the molding die in a semiconductor device manufacturing method according to a modification of the first embodiment, FIG. 9 is a perspective view showing a state in which an integral type rubbery cleaning resin is disposed to the molding die shown in FIG. 8, and FIG. 10 is a translucent diagram showing a state in which the rubbery cleaning resin shown in FIG. 9 is disposed in a clamped state of the molding die.

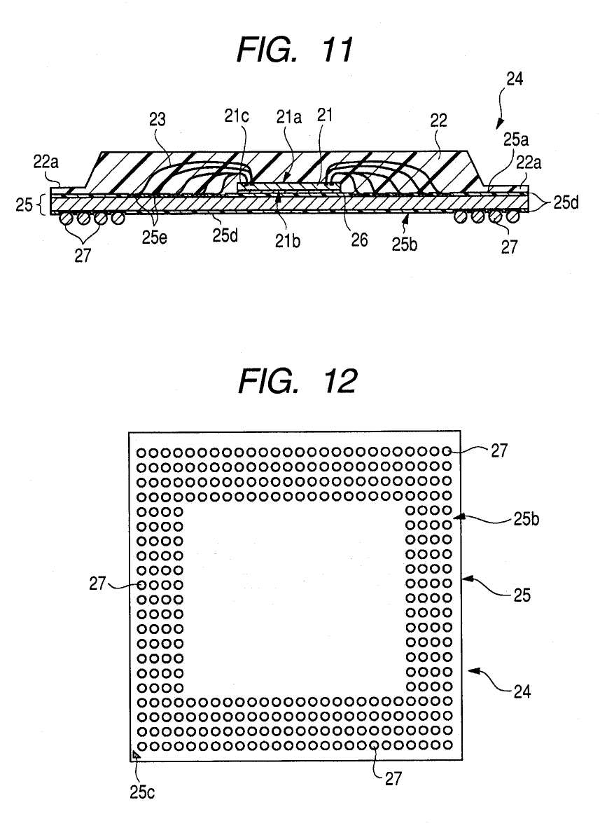

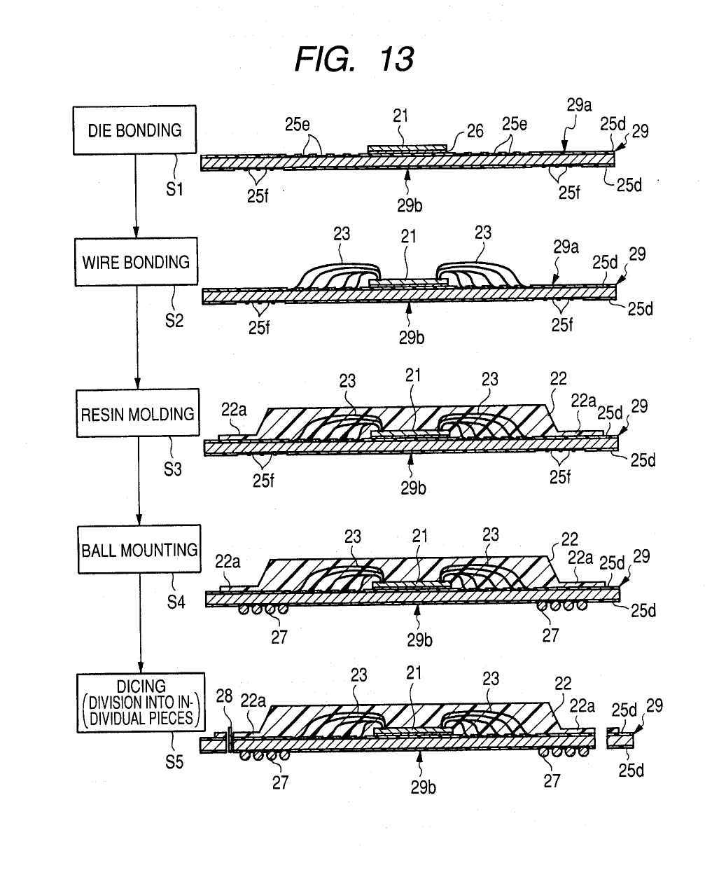

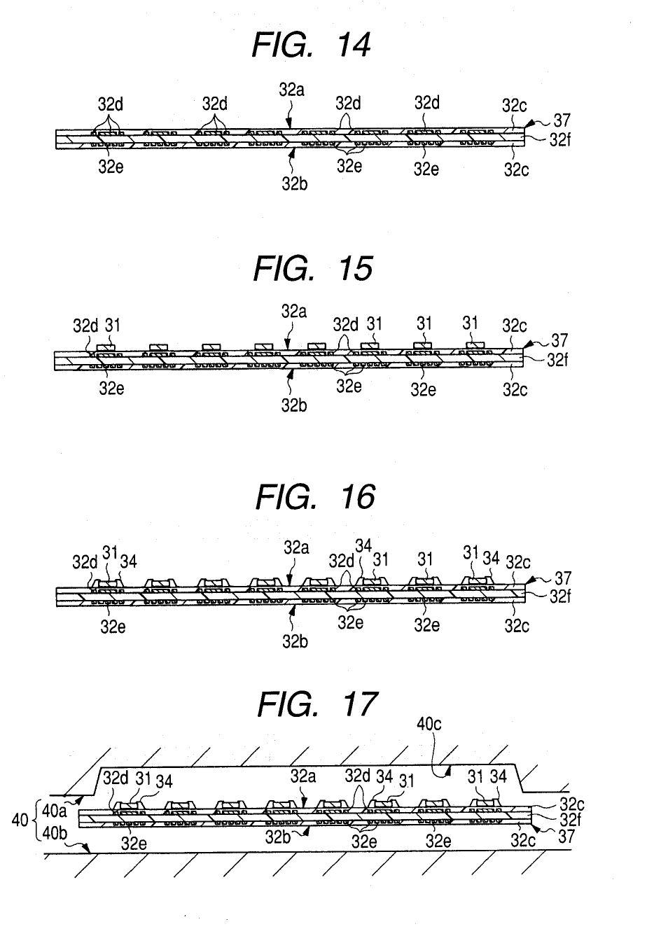

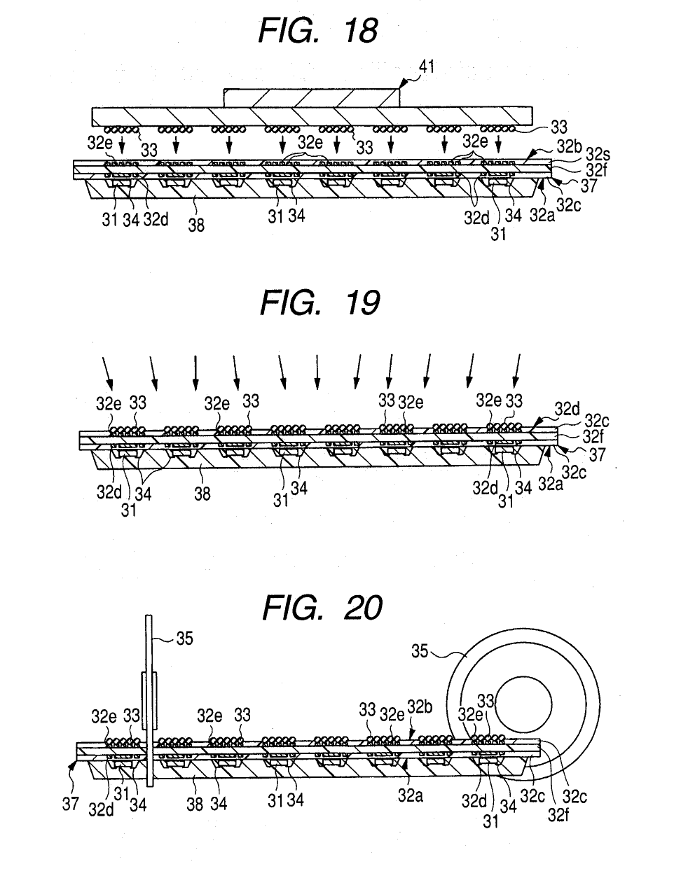

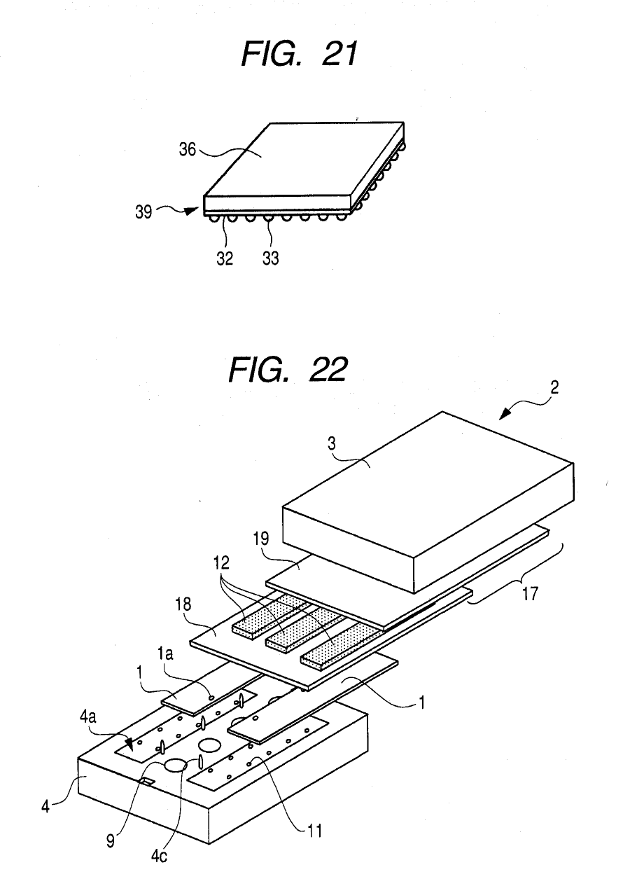

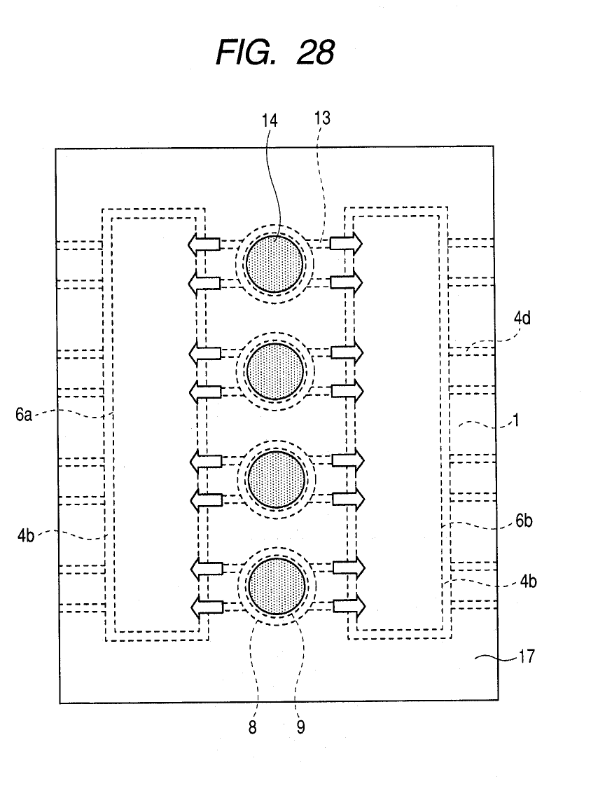

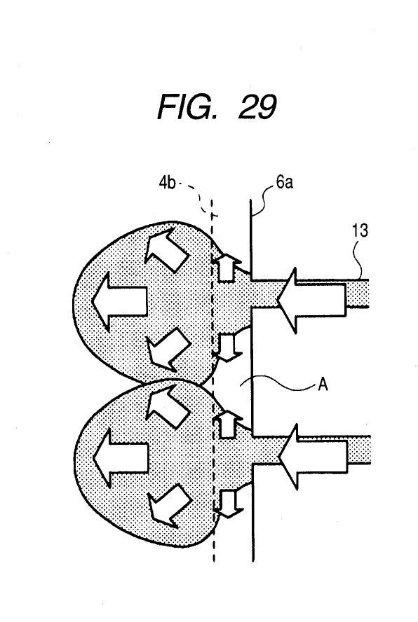

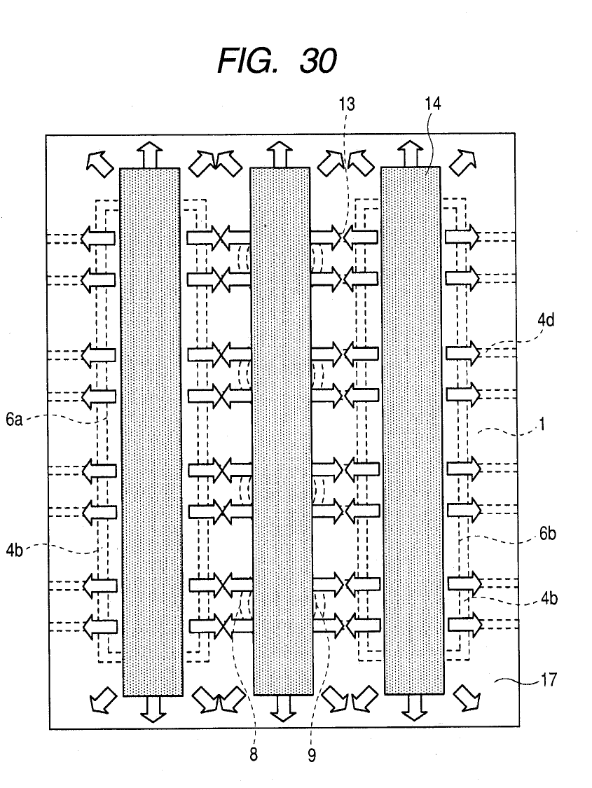

Further, FIG. 11 is a sectional view showing a structural example of a semiconductor device assembled by the semiconductor device manufacturing method of the first embodiment, FIG. 12 is a back view showing a structural example of the semiconductor device shown in FIG. 11, FIG. 13 is a manufacturing process chart showing an example of procedure for assembling the semiconductor device shown in FIG. 11, FIG. 14 is a sectional view showing the structure of a matrix substrate used in semiconductor device assembly according to a modification of the first embodiment, FIG. 15 is a sectional view showing the structure after die bonding in the semiconductor device assembly according to the modification of the first embodiment, FIG. 16 is a sectional view showing the structure after wire bonding in the semiconductor device assembly according to the modification of the first embodiment, FIG. 17 is a sectional view showing the structure during resin molding in the semiconductor device assembly according to the modification of the first embodiment, FIG. 18 is a sectional view showing the structure in mounting solder balls in the semiconductor device assembly according to the modification of the first embodiment, FIG. 19 is a sectional view showing the structure in washing the solder balls in the semiconductor device assembly according to the modification of the first embodiment, FIG. 20 is a sectional view showing the structure in individual dicing in the semiconductor device assembly according to the modification of the first embodiment, FIG. 21 is a perspective view showing the structure of a semiconductor device according to the modification of the first embodiment, FIG. 28 is a plan view showing a state of a cleaning resin pouring pressure, FIG. 29 is a partial enlarged view of FIG. 28, and FIG. 30 is a plan view showing a state of diffusion of the cleaning resin.

The semiconductor device manufacturing method of this first embodiment is concerned with cleaning of a molding die (resin molding die) used in a resin sealing process during assembly of the semiconductor device. According to the cleaning method of this first embodiment, when cleaning the molding die 2, as shown in FIGS. 1 and 2, two types of separate sheets, which are a cleaning sheet (molding die cleaning sheet) 17 and mask sheets (mask substrates, dummy substrates) 1, as well as rubbery cleaning resin bars 12, are interposed between an upper mold (first mold) 3 and a lower mold (second mold) 4 of the molding die 2 and cleaning is performed using pressurized and molten cleaning resin 5 almost simultaneously with clamping of the molding die.

More specifically, the cleaning sheet 17 and the rubbery cleaning bars 12 are disposed on the molding die and the cleaning resin 5 resulting from the rubbery cleaning resin bars 12 being melted by the die clamping pressure and heat and changed in shape is filled into the molding die 2 and is entwined and removed by the cleaning sheet 17, thereby cleaning the interior of the molding die 2.

After the cleaning, the cleaning sheet 17 is discharged to waste, while it is preferable that the mask sheet 1 be re-utilized repeatedly because it is expensive in comparison with the cleaning sheet 17. The reason why the mask sheet 1 is expensive is that it is necessary to form highly accurate set pin holes (positioning holes) 1a corresponding to set pins (substrate positioning pins) 4c formed on the lower mold 4, and highly accurate substrate dimensions are required, and that therefore the mask sheet 1 is fabricated by etching, pressing and machining works.

The molding die 2 shown in FIG. 1 is a one-side molding type die for resin-molding a product (semiconductor device) having a substrate such as CSP (Chip Size Package) or BGA and is also a transfer molding type die. Plural suction holes 11 are formed in the lower mold (second mold) 4 to fix the substrate by suction on the lower mold 4. Therefore, the suction holes 11 are open to a mold surface 4a as a mating surface of the lower mold 4.

The suction holes 11 are for fixing a substrate which is used in assembling CSP or BGA. In the case where the substrate used in assembling CSP or BGA is relatively low in strength, e.g., a resin substrate, the substrate may be wrinkled by the resin pouring pressure in product assembly. To prevent such a phenomenon the suction holes 11 act to suck and stretch the substrate. At the same time, it is also intended to correct warping of the substrate.

As shown in FIG. 2, the upper mold (first mold) 3 of the molding die 2 is formed with cavity blocks 42, culls 7, runners 8 and gates 13, with cavities 6 being formed in the cavity blocks 42, respectively. On the other hand, the lower mold 4 is formed with not only the suction holes 11 shown in FIG. 1 which are open to the mold surface 4a but also plural pots 9 (a row of the pots 9 will hereinafter be referred to as a pot row 43) with plungers 10 disposed therein to push out a product sealing resin.

In the molding die 2 used in this first embodiment, concave stepped portions (second recesses) 4b shallower than the cavities 6 are formed in gates 13-side end portions (edge portions) of the cavities (first recesses) 6 of the upper mold 3. When assembling such a BGA 24 as shown in FIG. 11, the stepped portions 4b of the upper mold 3 form thin resin portions 22a in dicing portions on the substrate. With the thin resin portions 22a, the substrate and the resin can be cut at a time when cut into individual pieces as semiconductor devices after the sealing with resin. As a result, metal burrs caused by wiring or the like can be embraced by the resin so as not to become exposed. Thus, the molding die 2 shown in FIG. 2 is formed with the stepped portions 4b for forming the thin resin portions 22a. The amount of the cleaning resin 5 filled into the stepped portions 4b is smaller than that of the cleaning resin 5 filled into the cavities 6. Therefore, the thickness of each thin resin portion 22a is smaller than that of a sealing body 22 formed in each cavity 6.

The rubbery cleaning resin bars 12 are, for example, such elongated unvulcanized rubber bars (rectangular parallelepiped) and are melted into cleaning resin under the die temperature and a low pressure. The cleaning resin can remove contaminants such as dust particles and impurities, as well as oxides, fixed and deposited to the interior of the molding die 2. An example is an unvulcanized rubbery cleaning resin containing natural rubber, silicone rubber, or fluorine-containing rubber, as a main component each alone or as a mixture.

The cleaning sheet 17 is for entwining and removing the cleaning resin 5 which results from the rubbery cleaning resin bars 12 being pressurized and melted. It is preferable that the cleaning sheet 17 be formed using a material superior in adhesion to the cleaning resin 5, e.g., non-woven fabric, paper, or resin.

Also in point of structure it is preferable for the cleaning sheet 17 to have fibers or the like of a three-dimensionally coarse structure so as to permit the cleaning resin 5 to be easily entwined or so that the passage resistance of filler (e.g., glass) contained in the cleaning resin 5 and the flow resistance of the cleaning resin 5 become lower (so as to permit impregnation and penetration of the cleaning resin 5). Particularly, it is preferable that the structure in question be a net-like three-dimensional structure having plural voids larger than the fiameter of the filler contained in the cleaning resin 5.

The cleaning sheet 17 is of a size which covers the whole of the die and has a thickness which prevents leakage of the cleaning resin 5 from the sheet 17. More particularly, the cleaning sheet 17 is thinner than the mask sheet 1 and the weight thereof, as well as the weight per unit area, is, say, 55 g/cm² or less.

However, even in the case where the cleaning sheet 17 is not of a net-like three-dimensional structure, by forming apertures in positions corresponding to the pot row 43 in the lower mold 4, it is possible to reduce the flow resistance of the cleaning resin 5 and prevent the resin from being unfilled into the die.

It is necessary that cleaning be done up to extreme ends including air vents 4d of a first cavity 6a of the first cavity block 42 out of right and left cavity blocks and a second cavity 6b of the second cavity block, and the rubbery cleaning resin bars 12 substantially spread as in FIG. 6. Therefore, the cleaning sheet 17 has a size which covers the portion between the upper mold 3 and the lower mold 4 including pots 9 and culls 7 provided at least in positions adjacent to the right and left cavity blocks 42 and cavities 6, in other words, a size which covers the entire die. This is also a feature of this embodiment and is preferable in point of working efficiency.

Since the cleaning sheet 17 has a size covering the entire die, with the four sides of the die serving as a guideline, the cleaning sheet 17 can be set to the lower die 4 easily.

Moreover, in the case where the cleaning sheet 17 has a size which covers the entire die, there accrues an effect of suppressing leakage of the cleaning resin 5 from the outside or edge portion of the lower mold 4. In the event of leakage of the cleaning resin 5, the leaking resin is entwined and integrated by the cleaning sheet 17 and thus can be removed easily. This is preferable in point of working efficiency.

It is preferable for the cleaning sheet 17 to have a high heat resistance able to withstand a resin molding temperature (170° to 180° C.) of the molding die 1.

In view of the above points it is preferable that the cleaning sheet 17 be formed of a material containing a structure derived from a plant polymer such as paper or non-woven fabric. For further improving the heat resistance of the cleaning sheet 17 containing the aforesaid plant polymer-derived structure it is preferable that a substance higher in heat resistance than the structure be mixed into the cleaning sheet or is coated onto the sheet surface. Such a highly heat-resistant substance is, for example, a fluorine-containing resin or a silicone resin. The structure of the cleaning sheet 17 is not limited to a three-dimensional coarse structure, but may be a structure which is relatively high in both density and hardness. In this case, it is necessary for the cleaning sheet 17 to have apertures corresponding to the pot row 43. It is preferable that the hardness of the cleaning sheet 17 be as close as possible to the hardness of the molding die from the standpoint of dust, resin and mold release.

Next, a molding die cleaning method as the semiconductor device manufacturing method of this first embodiment will be described below with reference to FIGS. 1 to 7.

First, there are provided a cleaning sheet 17 able to entwine and remove the cleaning resin 5 and further permitting impregnation and penetration of rubbery cleaning resin bars 12, mask sheets (mask substrates, dummy substrates) 1 releasable from the cleaning resin 5, and rubbery cleaning resin bars 12.

It is preferable that the mask sheets 1 be formed of a material superior in releasability from the cleaning resin 5 in comparison with the cleaning sheet 17 so as to be re-utilized repeatedly in the cleaning of the molding die 2. For example, the mask sheets 1 are formed of a material not permitting the passage of resin therethrough, e.g., metal such as copper, copper alloy, or iron-Ni alloy, or paper or resin.

It is preferable that the mask sheets 1 be low in bonding force for the cleaning resin 5 also in comparison with a resin substrate which is used in product assembly.

The mask sheets 1 are disposed onto the mold surface 4a of the lower mold 4 in cleaning the molding die 2 and cover the suction holes 11 which are open to the mold surface 4a, whereby it is intended to prevent adhesion of the cleaning resin 5 to the mold surface 4a of the lower mold 4 and thereby also prevent entry of the cleaning resin 5 into the suction holes 11 which would cause resin clogging. This is a feature and effect of the mask sheets 1.

Thus, it is preferable for the mask sheets 1 to have a structure relatively high in density so as not to permit permeation of resin and higher in hardness than the cleaning sheet 17.

After the provision of the cleaning sheet 17, mask sheets 1 and rubbery cleaning resin bars 12, first as shown in FIG. 1, the two mask sheets 1 are disposed on the lower mold 4 correspondingly to mating cavities 6 so that the suction holes 11 for vacuum suction which are open to the mold surface 4a of the lower mold 4 in the molding die 2 are covered with the mask sheets 1. At this time, set pins 4c projecting from the mold surface 4a of the lower mold 4 are inserted into set pin holes 1a formed in the mask sheet 1 to position and dispose the mask sheets 1 onto the lower mold 4. Further, the mask sheets 1 are brought into close contact with the mold surface 4a by vacuum exhaust, i.e., evacuation, from the suction holes 11.

The mask sheets 1 are of about the same size as the substrate used in assembling the semiconductor device, whereby it is possible to prevent the formation of resin burrs during injection of the cleaning resin and prevent variation of the surface pressure imposed on the mask sheets 1. By using mask sheets 1 high in levelness, the surface pressure of the cavity blocks 42 is imposed uniformly on the mask sheets, so that variation of the surface pressure does not occur and it is possible to prevent the formation of continuous resin burrs during product molding.

Then, as shown in FIG. 1, the cleaning sheet 17 is disposed between the upper mold 3 and the lower mold 4 on the mask sheets 1 (two right and left mask sheets 1) so as to include the cavities 6 of the molding die 2 within the sheet area. Further, the rubbery cleaning resin bars 12 which are each in the shape of rectangular parallelepiped are disposed at the positions of the cavities 6 (the first cavity 6a and the second cavity 6b) of the rectangular cavity blocks 42 and the pot row 43 so as to stretch under heat and pressure to the whole area of the molding die.

In this state, the upper and lower molds are clamped (mold clamping), whereby the rubbery cleaning resin bars 12 stretches uniformly to about three to five times its original size to effect cleaning.

Preferably, as shown in FIG. 2, one rubbery cleaning resin bar 12 is disposed correspondingly to the first cavity 6a out of the right and left cavities 6, another rubbery cleaning resin bar 12 is disposed correspondingly to the second cavity 6b, and a further rubbery cleaning resin bar 12 is disposed correspondingly to the gates 13 and pot row 43. That is, as shown in FIG. 2, it is preferable that three rubbery cleaning resin bars 12 be separately disposed correspondingly to the first cavity 6a, the second cavity 6b, and the gates 13 and pot row 43.

By thus disposing the elongated rubbery cleaning resin bars 12 of rectangular parallelepiped one by one to match both cavity blocks 42 and the gates 13, the cleaning resin 5 can be filled up to every corner of relatively small concaves and convexes formed in the molding die 2 in comparison with injecting the cleaning resin 5 into both cavities 6 with the pressure provided from the pot row 43; besides, by injecting the cleaning resin 5 overlappedly to the same positions as the rubbery cleaning resin bars 12 it is possible to diminish the formation of voids.

Thereafter, in a closed state of the suction holes 11 in the mold surface 4a of the lower mold 4 with the mask sheets 1, the cleaning sheet 17 and the rubbery cleaning resin bars 12 are clamped (mold clamping) by both lower mold 4 and upper mold 3, as shown in FIGS. 3 and 4.

Almost simultaneously with the mold clamping, the rubbery cleaning bars 12 are pressurized and heated and thereby melted into the cleaning resin 5, which in turn pervades between the upper and lower molds while permeating into the cleaning sheet 17 and stretching under heat and pressure. That is, the cleaning resin 5 is filled every corner of the mold surface 4a and relatively small concaves and convexes formed substantially throughout the whole area of the mold surface.

Thereafter, the cleaning resin 5 is cured to recover contamination on the mold surface into the cleaning resin 5. During the curing of the resin, the cleaning resin 5 is entwined into the cleaning sheet 17. That is, the cleaning resin 5 and the cleaning sheet 17 are united by re-solidifying.

Subsequently, the molding die 2 is opened (opening) as shown in FIG. 5 and the cleaning sheet 17 with contamination and the cleaning resin 5 adhered thereto, as well as the mask sheets 1, are taken out from between the upper and lower molds as shown in FIG. 6.

Then, the cleaning sheet 17 and the mask sheets 1 are separated from each other.

In this case, only the mask sheets 1 can be peeled off while allowing the cleaning resin 5 to remain on the cleaning sheet 17 side because the cleaning sheet 17 is formed using a material high in adhesion to the cleaning resin 5 and further because the mask sheets 1 are formed using a material easily releasable from the cleaning resin 5. That is, as shown in FIGS. 6 and 7, the cleaning resin 5 and a mold release agent 16 are firmly affixed to fibers 15 of the cleaning sheet 17 and hence resin burrs do not remain on the mask sheets 1 side. Thus, the cleaning resin 5 and the mask sheets 1 can be separated from each other without any damage.

Consequently, after separation of the cleaning sheet 17 and the mask sheets 1 from each other, the mask sheets 1 can be re-utilized when cleaning the molding die 2 with use of the cleaning sheet 17. The cleaning sheet 17 with the cleaning resin 5 adhered thereto is discharged to waste after use or is re-utilized as a recycle source.

The mold release agent 16 may be impregnated, sprayed or coated beforehand to the contact surfaces of the cleaning resin 5 including the cleaning sheet 17 and the mask sheets 1, whereby the cleaning sheet 17 and the mask sheets 1 can be separated from each other in a more positive manner. In the case where the mask sheets 1 are metal sheets, the sheet surface may be treated at a high temperature to form an oxide film thereon, which is also effective in mold release.

Thus, according to the cleaning method of this first embodiment, the cleaning sheet 17 and the three rubbery cleaning resin bars 12 are disposed onto the molding die 2, then the rubbery cleaning resin bars 12 are pressurized and melted almost simultaneously with mold clamping, allowing the cleaning resin 5 to be filled into both cavities 6 to effect cleaning. Thus, as shown in FIG. 30, the rubbery cleaning resin bars 12 stretch and diffuse under heat and pressure newly as the cleaning resin 5 from their disposed positions toward the environs at an almost uniform injection pressure.

Consequently, the cleaning resin 5 can be filled also into portions (especially portion A in such a stepped portion as in FIG. 2) into which resin is difficult to enter with only the injection pressure from the pots 9.

More particularly, the cleaning resin 5 can be filled also into portions in which resin is difficult to enter with only the injection pressure from the pots 9 such as concave stepped portions 4b formed in end portions (edge portions) of the cavities 6 (first and second cavities 6a, 6b) around the gates 13, air vents 4d formed within the cavities 6 and portions remote from the pot row 43. In short, in the stepped portions of the gates-side end portions on which the final plunger pressure is difficult to be imposed and which portions lie in a direction opposite to the final plunger pressure-applied direction in the air vents 4d, the portions difficult to be filled with resin and the entire mold surface are filled with the unvulcanized rubbery cleaning resin bars 12.

As a result, it is possible to effect cleaning of the molding die 2 without being influenced by the resin injection pressure in transfer molding and by the flow paths in the molding die. Thus, it is possible to improve the cleanability of the molding die 2. It also becomes possible to remove the impurity derived from outgassing which occurs from the surface insulating film of the wiring substrate under the influence of heating and pressurizing of the molding die during molding for the formation of a sealing body.

In the method involving disposing the cleaning resin 5 in the pots 9 and injecting the cleaning resin into the cavities 6 through the gates 13, a non-fill defect of the cleaning resin 5 occurs in the stepped portions 4b on the side where the gates 13 are formed, as noted above. There is a possibility that the non-fill defect may be mitigated by increasing the push-out pressure of the plungers 10. However, there is a fear that the texture of the rubbery cleaning resin bars 12 used in this first embodiment may be damaged (deteriorated) if the pressure used in product molding is applied thereto.

In this embodiment, therefore, the mold clamping pressure in cleaning is set lower than the clamping pressure of the molding die 2 in product molding. For example, assuming that the mold clamping pressure in product molding (sealing body molding) is as high as 70 t, the mold clamping pressure in cleaning is preferably as low as 50 kg/cm² or so. By such a selection of pressure, there is no fear of a high pressure being applied to the rubbery cleaning resin bars 12 and hence it is possible to prevent the texture of the rubbery cleaning resin bars 12 from being damaged by the high mold clamping pressure. Moreover, since the rubbery cleaning resin bars 12 are disposed near the center of each cavity 6, the cleaning resin 5 can be filled uniformly into the cavities 6 and the stepped portions 4b adjacent to the cavities. Further, in the case where the molding die 2 is an individual molding type die, by setting the mold clamping pressure at a low pressure, it is possible to cause leakage of the cleaning resin 5 intentionally to the area between the cavities and thereby clean the cavity-to-cavity area of in the molding die 2.

It is preferable that the mold clamping be carried out at low speed. The pressure is adjusted by adjusting the stretching state of the rubbery cleaning resin bars 12. As components of the rubbery cleaning resin bars 12, melamine and an organic solvent such as a glycol ether are contained in vulcanized rubber. Therefore, after a cleaning shot using the rubbery cleaning resin bars 12, it is necessary to remove such a chemical as the aforesaid solvent from the molding die and perform cleaning by resin injection plural times from the pots 9 with use of cleaning resin (hereinafter referred to as “melamine cleaning resin”) comprising a commonly-used tableted melamine resin (not shown) so as not to exert a bad influence on succeeding products. The surface of the molding die 2 is plated with hard chromium (3 to 5μ) for preventing the corrosion of metal and for improving the mold releasability of the molding resin. However, the hard chromium plating may be worn out and separated from the surface of the molding die 2 which is high in working efficiency. If molding is performed in this state, the die surface is apt to be stained and the stain becomes difficult to be removed. If a chemical such as the foregoing organic solvent remains on the surface of the molding die 2 with chromium plating worn out and separated, the die surface (metal) may be corroded.

Therefore, after a cleaning shot using the rubbery cleaning resin bars 12, it is necessary to effect cleaning plural times with use of the melamine cleaning resin. This is particularly effective for the molding die which is markedly stained in the use of a glass fabric-based epoxy resin substrate used mainly in MAP, BGA or CSP and coated with resist or the like.

As to the mechanism for operating the molding apparatus, the cleaning work using the rubbery cleaning resin bars 12 may be done not only by an manual operation using the molding apparatus but also by an automatic operation using mechanism of arbitrarily setting low speed and low pressure and opening the molding die automatically after the lapse of a curing time.

As to the cleaning process for the molding die 2, since the cost of the rubbery cleaning resin bars 12 is high, there may be adopted a method wherein the cleaning using the rubbery cleaning resin bars 12 is not performed every shot, but after once performing the cleaning with use of the rubbery cleaning resin bars 12, cleaning is performed plural shots with use of the melamine cleaning resin 5 by injection of the resin from the pots 9, whereby it is possible to improve the cleaning effect while suppressing an increase of cost and cleaning work expenses.

In the case where the cleaning of the molding die 2 is to be done to a satisfactory extent and if there is adopted only the method of injecting the cleaning resin 5 from the pots 9, eight shots or more are needed for the removal of contamination, but if the method is combined with the method using both rubbery cleaning resin bars 12 and melamine cleaning resin, the cleaning work for the molding die 2 is completed by three shots.

Thus, by an appropriate combination of the method using the rubbery cleaning resin bars 12 and the method using the cleaning resin by injection from the pots 9 it is possible to effect optimum (highly efficient) cleaning in point of both cost and cleaning effect. More particularly, by performing the cleaning of the molding die in accordance with the method using the cleaning sheet 17 and the rubbery cleaning resin bars 12 in a disposed state of the mask sheets 1, then using a new cleaning sheet 17 and re-utilizing the mask sheets 1 already used and further by applying the method using the cleaning resin 5 by injection from the pots 9 with the sheets 17 and 1 disposed in the molding die 2, it is possible to reduce the cost of the cleaning work.

Next, with reference to FIGS. 8 to 10, a description will be given about a molding die cleaning method according to a modification of the first embodiment. When disposing the rubbery cleaning resin bars 12 onto the molding die correspondingly to the cavity blocks 42 shown in FIG. 2, there is used as a substitute for the rubbery cleaning resin bars an integral type rubbery cleaning resin 14 correspondingly to the first and second cavities 6a, 6b and the gates 13. For example, as shown in FIG. 10, the integral type rubbery cleaning resin 14 has a shape such that two apertures 14a are positioned over the mask sheets 1.

In this case, the portions (e.g., air vents 4d) around the cavities into which the cleaning resin 5 is relatively difficult to enter can also be filled with the cleaning resin 5, thus making it possible to improve the cleaning effect. Further, because of an integral type rubbery cleaning resin, the positioning of the rubbery cleaning resin 14 can be done easily and it is possible to effect cleaning throughout the whole area of the lower mold 4, in comparison with the use of plural, separate, rubbery cleaning resin bars 12.

Next, the following description is provided about the structure of a BGA 24 shown in FIG. 11 as an example of the semiconductor device assembled by the semiconductor device manufacturing method of the first embodiment after completion of the above cleaning process for the molding die 2.

The BGA 24 comprises a package substrate 25 having a main surface 25a with a semiconductor chip 21 mounted thereon through a die bonding agent 26, plural wires 23 for electrically connecting pads 21c formed on a main surface 21a of the semiconductor chip 21 and bonding electrodes 25e formed on a main surface 25a of the package substrate 25 with each other, a sealing body 22 which seals the semiconductor chip 21 and the plural wires 23 with resin, and plural solder balls 27 formed on a back surface 25b of the package substrate 25. A plane shape intersecting the thickness direction of the semiconductor chip 21 is a square.

As shown in FIG. 12, the plural solder balls 27 serving as external terminals are arranged in a lattice shape on the back surface of the package substrate 25 along the outer periphery exclusive of the central portion.

As shown in FIG. 11, thin resin portions 22a are formed at end portions of both sides in one of two opposed directions of the sealing body 22. The thin resin portions 22a are formed thinner than the area of the sealing body 22 where the semiconductor chip 21 is mounted and it is formed integrally with the sealing body 22. The thin resin portions 22a are formed so that both substrate and resin (the thin resin portions 22a) are cut at the time of division into individual pieces as semiconductor devices after the resin-sealing in assembling the BGA 24 in order for metal burrs caused by wiring, etc. to be embraced by the resin to prevent exposure thereof.

The package substrate 25 is formed of a base material such as, for example, glass fabric-based epoxy resin and has a multi-layer wiring structure. As shown in FIG. 11, on the main surface 25a of the package substrate 25 there are formed plural bonding electrodes 25e which are connected to wires 23. On the other hand, as to the back surface 25b of the package substrate 25, the solder balls 27 are connected thereto and such plural lands 25f as shown in FIG. 13 are formed thereon.

The other areas of the surface and back surface of the package substrate 25 than the areas where the bonding electrodes 25e and lands 25f are exposed are covered with solder resists 25d. Further, as shown in FIG. 12, an index 25c which indicates the direction of BGA 24 is formed at a position near a corner of the back surface 25b of the package substrate 25.

The sealing resin for forming the sealing body 22 and the thin resin portion 22a in the BGA 24 is, for example, a thermosetting epoxy resin with filler mixed therein. The semiconductor chip 21 is formed by silicon for example and plural pads 21c and a semiconductor integrated circuit are formed on the main surface 21a of the semiconductor chip. The wires 23 are gold wires for example.

Next, how to fabricate the BGA 24 will be described below with reference to the manufacturing process flow chart of FIG. 13.

First, there is provided a matrix substrate 29 formed with plural device areas as device-forming areas and thereafter die bonding of step S1 is performed. That is, each device area on the matrix substrate 29 and the semiconductor chip 21 are connected with each other. In the illustrated example, the semiconductor chip 21 is fixed onto the matrix substrate 29 through a die bonding material 26. In this way the back surface 21b of the semiconductor chip 21 and the matrix substrate 29 are connected together through the die bonding material 26.

After the die bonding there is performed wire bonding of step S2. More specifically, as shown in FIG. 11, the pads 21c of the semiconductor chip 21 and the corresponding bonding electrodes 25e of the package substrate 25 are connected with each other through wires 23 to connect the semiconductor chip 21 and the package substrate 25 with each other electrically.

After the wire bonding there is performed resin molding of step S3. The upper mold 3 of the molding die 2 used in the resin molding step is formed with concave stepped portions 4b at end portions of the cavities 6. The stepped portions 4b are for forming the thin resin portions 22a shown in FIG. 11.

Resin molding is performed to form not only the sealing body 22 on the main surface 29a of the matrix substrate 29 but also the thin resin portions 22a integrally with the sealing body 22. Thereafter, the sealing resin is cured and the molding die is opened to take out the matrix substrate 29 from the molding die 2.

The sealing body and the thin resin portions 22a are formed in each device area of the matrix substrate 29 thus taken out from the molding die 2.

After the resin molding there is performed ball mounting of step S4 shown in FIG. 13. In this ball mounting step, solder balls 27 are attached to the plural lands 25b formed on the back surface 29b of the matrix substrate 29.

Thereafter, dicing is performed in step S5. The dicing is performed using a blade 28 to divide the substrate into individual pieces as semiconductor devices. At this time, since the thin resin portions 22a are formed outside the sealing body 22, both thin resin portions 22a and wiring are cut with the blade 28. By thus cutting both wiring and resin (thin resin portions 22a) with the blade 28, the sealing resin induces a dressing action for the blade 28, so that copper burrs (metal burrs) being dragged and tending to get entangled are cut by the sealing resin and hence can be prevented from adhering to the blade 28 and causing clogging.

The assembly of BGA 24 is completed by such dicing into individual pieces.

The molding die 2 used in the resin molding step during assembly of the BGA 24 is formed with concave stepped portions 4b at end portions of the cavities (first and second cavities 6a, 6b) of the cavity blocks 42, so by cleaning the molding die 2 with use of the cleaning method of this first embodiment, even the portions into which resin is difficult to enter with only the injection pressure from the pots 9 can be filled with the cleaning resin 5.

Thus, the cleaning of the molding die 2 can be carried out without being influenced by variations in the resin injection pressure in transfer molding and the flow paths of the molding die 2. Consequently, it is possible to improve the cleanability of the molding die 2.

The following description is now provided about the structure of a BGA 39 shown in FIG. 21 as a modification of the semiconductor device assembled by the semiconductor device manufacturing method of the first embodiment.

In the BGA 39 as the modified semiconductor device shown in FIG. 21, plural solder balls 33 are arranged in a lattice shape on a back surface 32b of a package substrate 32 having wiring lines 32d.

The BGA 39 is provided with a resin sealing body 36 for sealing a semiconductor chip 31. With use of a matrix substrate 37, resin molding (“block molding” hereinafter) is performed in a state in which plural device areas on the matrix substrate 37 are all covered. A block molding portion 38 thus formed and shown in FIG. 18 and a matrix substrate 37 are diced into individual pieces as semiconductor devices after the resin sealing.

As shown in FIGS. 14 to 21, the BGA 39 is made up of the package substrate 32, the semiconductor chip 31 mounted on the package substrate 32, bonding wires 34 for connecting surface electrodes on the semiconductor chip 31 and terminals of the package substrate 32 with each other, the resin sealing body 36 formed on a main surface 32a side of the package substrate 32 to seal the semiconductor chip 31 and the bonding wires 34, and the plural solder balls 33 provided on the back surface 32b of the package substrate 32.

Solder resists 32c are formed of, for example, a polyimide resin on both the main surface 32a and the back surface 32b of the package substrate 32. The package substrate 32 further has in the interior thereof a base material 32f such as a glass fabric-based epoxy resin. On the back surface 32b of the package substrate 32 there are formed plural bump lands 32e to which the solder balls 33 are attached. The package substrate 32 is formed with plural wiring lines 32d formed by copper foil for example. Further formed on the package substrate 32 are solder resists 32c as insulating layers which cover a portion of the wiring lines 32d.

The molding resin used for block molding in the resin molding step is, for example, a thermosetting epoxy resin and the block molding portion 38 shown in FIG. 18 is formed thereby. Further, the substrate is divided to individual pieces by subsequent dicing to form the resin sealing body 36.

As shown in FIG. 15, the semiconductor chip 31 is formed of silicon for example and a semiconductor integrated circuit is formed in the interior of the chip.

The bonding wires 34 are gold wires for example.

Next, a description will be given below about how to fabricate the BGA 39.

First, the matrix substrate 37 shown in FIG. 14 is provided.

Thereafter, semiconductor chips 31 are mounted to the device areas on the matrix substrate 37, as shown in FIG. 15. More specifically, semiconductor chips 31 are mounted respectively to the device areas on the matrix substrate 37 and are bonded to the die bonding material applied to the device areas.

Thereafter, wire bonding is performed, as shown in FIG. 16. More specifically, the surface electrodes of the semiconductor chips and terminals of the matrix substrate 7 are connected together electrically by wire bonding with use of bonding wires 34 such as gold wires.

Subsequently, resin molding is performed using an upper mold 40a and a lower mold 40b of a molding die 40, as shown in FIG. 17.

In the upper mold 40a (the lower mold 40b will do) of the molding die 40 is formed with a cavity 40c of a size able to cover all of the plural semiconductor chips 31 mounted in the plural device areas respectively of the matrix substrate 37.

In the resin molding step shown in FIG. 17, the matrix substrate 37 with the semiconductor chips 31 mounted on the device areas is set between the upper mold 40a and the lower mold 40b of the molding die 40 to cover all of the plural device areas with a single cavity 40c. Thereafter, the matrix substrate 37 is clamped by the upper and lower molds 40a, 40b.

In this state, the molding resin is fed to the cavity to mold the plural semiconductor chips 31 and the bonding wires 34 all together.

As the molding resin there is used, for example, a thermosetting epoxy resin.

In this way there is formed the block molding portion 38 which covers all of the plural semiconductor chips 31, as shown in FIG. 18.

Thereafter, the solder balls 33 are mounted as in FIG. 18.

More specifically, the back surface 32b of each package substrate 32 in the matrix substrate 37 is faced up and a ball mounting jig 41 which chucks plural solder balls 33 is disposed above the back surface 32b, then the solder balls 33 are transferred from above the matrix substrate 37 onto the plural bump lands 32e formed on the back surface 32b of the package substrate 32.

In this case, the solder balls 33 are melted, for example, by reflow of infrared light so as to be bonded respectively to the bump lands 32e. Such mounting of the solder balls 33 may be done before or after dicing which is performed after the block molding.

Thereafter, as shown in FIG. 19, the solder balls 33 are washed in washing equipment including a vessel for washing flux with a surfactant, a vessel for washing oil, fat, solder waste and contaminant, and a vessel for drying.

Further, as shown in FIG. 20, dicing is performed using a cutting blade 35 for division into individual pieces as semiconductor devices. More particularly, the block molding portion 38 formed by resin molding and the matrix substrate 37 are divided device area by device area with use of the blade 35.

That is, the matrix substrate 37 is diced by the blade 35 to afford such a BGA 39 as shown in FIG. 21. The assembly of the BGA is now completed.

The cavity 40c of the molding die 40 used for resin molding in assembling the BGA 39 of the modification is large and therefore, by cleaning the molding die 40 in accordance with the molding die cleaning method of the first embodiment, even the remote portions into which resin is difficult to enter with only the injection pressure from the pots 9 can be filled with the cleaning resin 5.

In this way cleaning of the molding die 40 can be done without being influenced by variations in the resin injection pressure during transfer molding and hence it is possible to improve the cleanability of the molding die 40.

### Second Embodiment

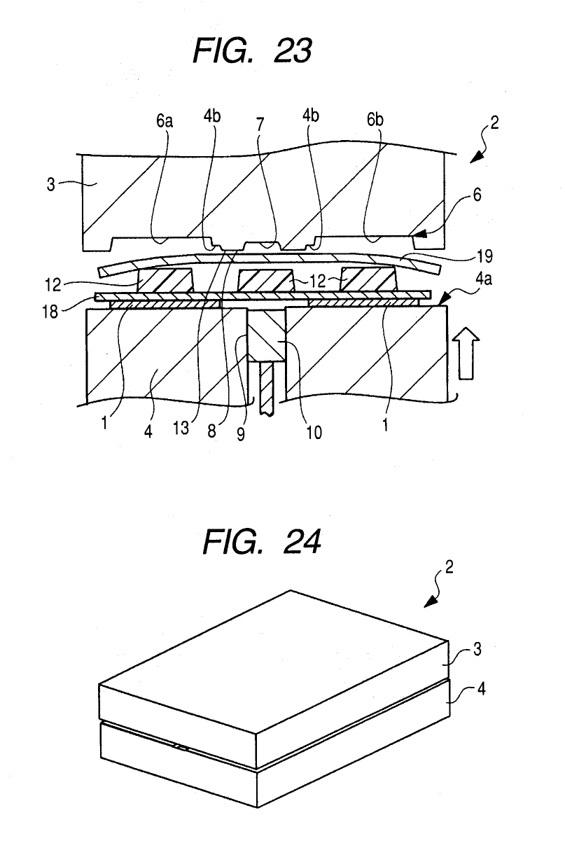

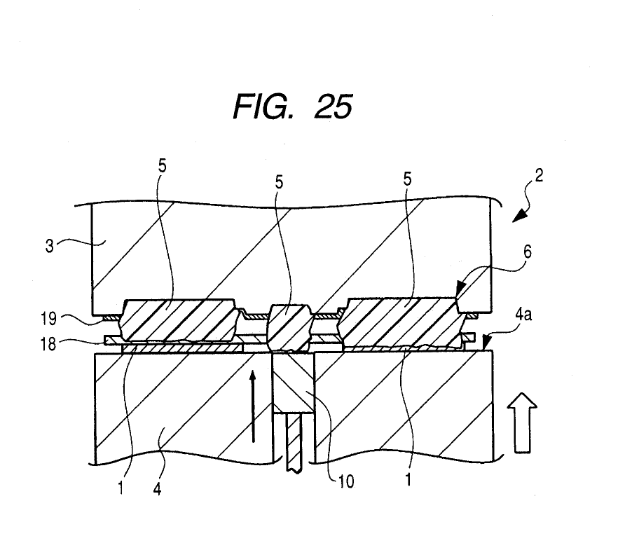

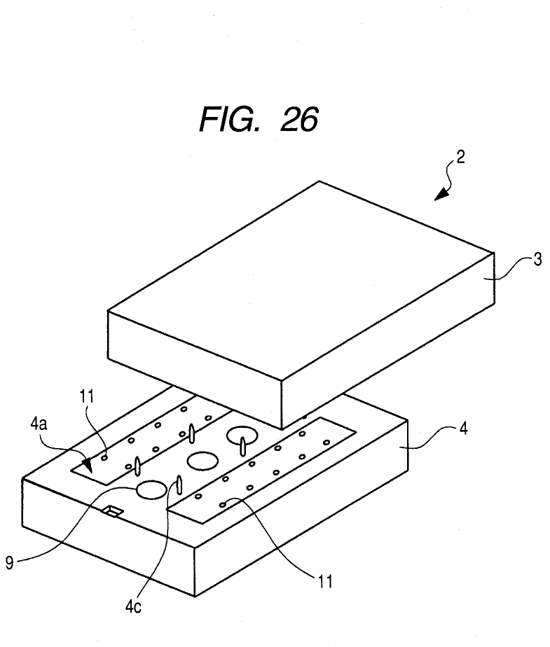

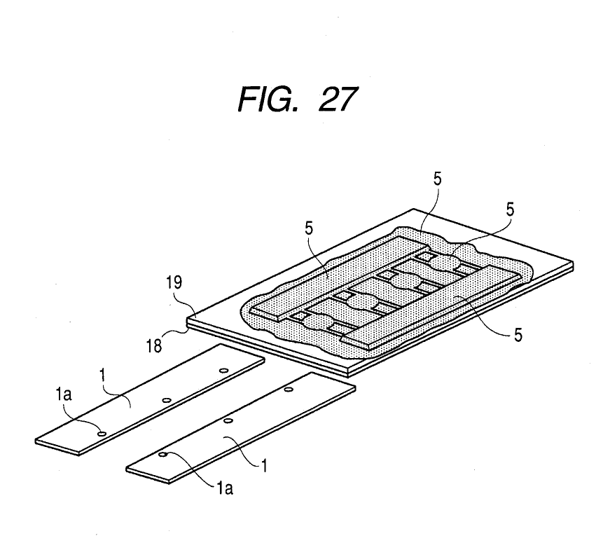

FIG. 22 is a perspective view showing an example of a state in which rubbery cleaning resin bars are disposed to the molding die in a semiconductor device manufacturing method according to a second embodiment of the present invention, FIG. 23 is an enlarged partial sectional view showing a structural example after the disposition of the rubbery cleaning resin bars shown in FIG. 22, FIG. 24 is a perspective view showing a structural example in a clamped state of the molding die in the semiconductor device manufacturing method of the second embodiment, and FIG. 25 is an enlarged partial sectional view showing a structural example in the clamped state of the molding die shown in FIG. 24. Further, FIG. 26 is a perspective view showing a structural example in an open condition of the molding die in the semiconductor device manufacturing method of the second embodiment and FIG. 27 is a perspective view showing an example of mask sheets and a molding die cleaning sheet both taken out from the molding die which is in the open condition shown in FIG. 26.

In the semiconductor device manufacturing method of this second embodiment, as shown in FIGS. 22 to 27, when cleaning the molding die 2, cleaning sheets are disposed above and below the rubbery cleaning resin bars 12 to improve the cleaning effect particularly for the upper mold 3.

More specifically, as shown in FIG. 22, mask sheets 1 are disposed on the mold surface 4a of the lower mold 4 to close the suction holes 11 and then a lower cleaning sheet (a first molding die cleaning sheet) 18 which permits impregnation and penetration of the rubbery cleaning resin bars 12 is disposed on the mask sheets 1. Thereafter, for example three rubbery cleaning resin bars 12 are disposed on the lower cleaning sheet 18 and further an upper cleaning sheet (a second molding die cleaning sheet) 19 which permits impregnation and penetration of the rubbery cleaning resin bars 12 is disposed on the rubbery cleaning resin bars to effect cleaning of the molding die 2.

By thus sandwiching the rubbery cleaning resin bars 12 in between the lower cleaning sheet 18 and the upper cleaning sheet 19, even if an impurity such as silicon adheres to the upper mold 3 through the upper cleaning sheet 19, the cavity 6 in the upper mold 3 can be filled with the cleaning resin 12 while allowing the upper cleaning sheet 19 to follow the shape of the inner wall of the cavity, as shown in FIG. 25. When cleaning is done using the rubbery cleaning resin bars 12, there sometimes is a case where air-including voids formed by stretching of the resin under clamping (mold clamping) heat and pressure remains in the molding die as stain and contamination. In this connection, when clamping (mold clamping) the molding die as in FIG. 24, the rubbery cleaning resin bars 12 are sandwiched in between the lower cleaning sheet 18 and the upper cleaning sheet 19 to effect cleaning, whereby voids developed from the rubbery cleaning resin bars 12 are absorbed by the sheets, that is, there are formed neither voids nor stain or contamination.

Consequently, the upper cleaning sheet 19 comes into close contact with the inner wall of the cavity 6, so that the impurity adhered to the upper mold 3 can be entwined to the upper cleaning sheet 19 together with the cleaning resin 5 and hence can be removed.

Almost simultaneously with the mold clamping the rubbery cleaning resin bars 12 are pressurized and heated and thereby melted into the cleaning resin 5, which pervades between the upper and lower molds while permeating into the lower cleaning sheet 18 and the upper cleaning sheet 19. That is, substantially the whole area of the mold surface 4a of the molding die 2 is filled with the cleaning resin 5.

Thereafter, the cleaning resin 5 is cured to let the contamination of the mold surface be recovered into the cleaning resin 5. At this time, the cleaning resin is entwined by the cleaning sheet 17. That is, the cleaning resin 5 and the cleaning sheets 17 are rendered integral with each other by re-solidification.

Thus, the impurity holding effect can be further enhanced by disposing the cleaning sheets above and below the rubbery cleaning resin bars 12.

Also in this second embodiment, when cleaning of the molding die 2 is to be done to a satisfactory extent, seven shots are required if there is adopted only the method that uses the cleaning resin 5 injected from the pots 9, but only two shots are required if there is adopted the method that uses the rubbery cleaning resin bars 12.

Thus, by adopting the method using the rubbery cleaning resin bars 12 and the method using the cleaning resin 5 injected from the pots 9 properly selectively it is possible to effect cleaning which is optimum (highly effective) in point of both cost and cleaning effect.

More particularly, the cost of the cleaning work can be reduced by cleaning the molding die 2 in accordance with the method which uses the rubbery cleaning resin bars 12 in a disposed state of the lower cleaning sheet 18, upper cleaning sheet 19 and musk sheets 1 and thereafter adopting the method using the cleaning resin 5 injected from the pots 9 in a state in which a new cleaning sheet (a third molding die cleaning sheet) 18 and the already-used mask sheets 1 are disposed in the molding die.

As to the molding die cleaning process in the semiconductor device manufacturing method of this second embodiment, as well as other methods and effects, tautological explanations thereof will be omitted because they are the same as in the first embodiment.

Although the present invention has been described above by way of embodiments thereof, it goes without saying that the invention is not limited to the above embodiments, but that various changes may be made within the scope not departing from the gist of the invention.

For example, although in the above first and second embodiments the vacuum suction holes 11 are formed in the lower mold 4, the semiconductor method manufacturing methods of the above first and second embodiments are also applicable to a resin molding die having a cavity also in the lower mold 4 and not having the suction holes 11. In the resin molding die with suction holes 11 not formed in the lower mold 4, the mask sheets 1 may be omitted. In this case, the cleaning sheet(s) is (are) disposed either above or below or both above and below the rubbery cleaning resin bars 12 to effect cleaning of the resin molding die, whereby it is possible to attain the same cleaning effect as in the first and second embodiments.

As set forth above, the present invention is suitable for the resin molding die cleaning technique.

What is claimed is:

1. A method of manufacturing a semiconductor device, comprising the steps of:
(a) providing a molding die cleaning sheet for entwining cleaning resin;
(b) disposing the molding die cleaning sheet over a first mold or a second mold of a molding die correspondingly to a cavity block of the molding die, the molding die comprising a pair of the first mold and the second mold, and disposing a rubbery cleaning resin over the molding die cleaning sheet;
(c) clamping the molding die cleaning sheet and the rubbery cleaning resin by the first and second molds and filling cleaning resin formed by the pressure of the clamping into the cavity; and
(d) curing the cleaning resin and thereafter taking out the molding die cleaning sheet from the molding die.

2. A method of manufacturing a semiconductor device, comprising the steps of:
(a) providing a molding die cleaning sheet for entwining cleaning resin and a mask sheet capable of being easily released from the cleaning resin;
(b) covering vacuum suction holes with the mask sheet, the vacuum suction holes being open to a mold surface of either a first mold or a second mold of a molding die, the molding die comprising a pair of the first mold and the second mold, disposing the molding die cleaning sheet over the first or the second mold correspondingly to a cavity block of the molding die and further disposing a rubbery cleaning resin over the molding die cleaning sheet;
(c) closing the suction holes with the mask sheet, clamping the molding die cleaning sheet and the rubbery cleaning resin by the first and second molds, and filling cleaning resin formed by the pressure of the clamping into the cavity block;
(d) curing the cleaning resin and taking out the molding die cleaning sheet and the mask sheet from the molding die; and
(e) separating the molding die cleaning sheet and the mask sheet from each other.

3. The method according to claim 2, wherein the rubbery cleaning resin is an unvulcanized rubbery cleaning resin.

4. The method according to claim 2, wherein the cavity block comprises a first cavity and a second cavity, and when disposing the rubbery cleaning resin over the first or the second mold correspondingly to the cavity block in the step (b), one piece of the rubbery cleaning resin is disposed into the first cavity, another piece of the rubbery cleaning resin is disposed into the second cavity and a further piece of the rubbery cleaning resin is disposed into a central part of a pot row.

5. The method according to claim 2, wherein when disposing the rubbery clean resin over the first or the second mold correspondingly to the cavity block in the step (b), the rubbery cleaning resin is disposed integrally throughout the whole area correspondingly to all of flow paths including the first and second cavities and gates.

6. The method according to claim 2, wherein the clamping pressure in the step (c) is lower than the molding die clamping pressure in product molding.

7. The method according to claim 2, wherein, after the step (e), the suction holes are again closed with the mask sheet, the molding die cleaning sheet is clamped by the first and second molds, and in this state the interior of the cavity block is filled with the cleaning resin.

8. The method according to claim 2, wherein the molding die is formed with stepped portions at a gate-side end portion of the cavity block.

9. The method according to claim 2, wherein in the step (c), an unvulcanized rubbery cleaning resin is filled in a stepped position lying in a direction opposite to the direction in which a final plunger pressure of air vents is applied.

10. A method of manufacturing a semiconductor device, comprising the steps of:
(a) providing a molding die cleaning sheet for entwining cleaning resin;
(b) disposing two said molding die cleaning sheets over a first or a second mold of a molding die through a rubbery cleaning resin and correspondingly to a cavity block of the molding die, the molding die comprising a pair of the first mold and the second mold;
(c) clamping the two molding die cleaning sheets and the rubbery cleaning resin by the first and second molds and filling the cavity block with cleaning resin formed by the pressure of the clamping; and
(d) curing the cleaning resin and thereafter taking out the two molding die cleaning sheets from the molding die.

11. A method of manufacturing a semiconductor device, comprising the steps of:
(a) providing a molding die cleaning sheet for entwining cleaning resin and a mask sheet easily releasable from the cleaning resin;
(b) covering vacuum suction holes with the mask sheet, the vacuum suction holes being open to a surface of either a first mold or a second mold of a molding die, the molding die comprising a pair of the first mold and the second mold, and disposing two said molding die cleaning sheets over the first or the second mold through a rubbery cleaning sheet and correspondingly to a cavity block of the molding die;
(c) closing the suction holes with the mask sheets, clamping the two molding die clamping sheets and the rubbery cleaning resin by the first and second molds, and filling the cavity block with cleaning resin formed by the pressure of the clamping;
(d) curing the cleaning resin and thereafter taking out the two molding die cleaning sheets and the mask sheet from the molding die; and
(e) separating the two molding die cleaning sheets and the mask sheets from each other.

12. The method according to claim 11, wherein the rubbery cleaning resin is an unvulcanized rubbery cleaning resin.

13. The method according to claim 11, wherein when disposing the two molding die cleaning sheets over the first or the second mold through the rubbery cleaning resin and correspondingly to the cavity block in the step (b), one piece of the rubbery cleaning resin is disposed into a first cavity, another piece of the rubbery cleaning resin is disposed into a second cavity and a further piece of the rubbery cleaning resin is disposed into a pot row.

14. The method according to claim 11, wherein when disposing the two molding die cleaning sheets over the first or the second mold through the rubbery cleaning resin and correspondingly to the cavity block in the step (b), the rubbery cleaning resin is disposed integrally throughout the whole area correspondingly to first and second cavities and gates.

15. The method according to claim 11, wherein the clamping pressure in the step (c) is lower than the clamping pressure in the step (c) is lower than the molding die clamping pressure in product molding.

16. The method according to claim 11, wherein after the step (e), the suction holes are again closed with the mask sheet, the molding die cleaning sheets are clamped by the first and second molds, and in this state the interior of the cavity block is filled with the cleaning resin.

17. The method according to claim 11, wherein the molding die is formed with stepped portions at a gate-side end portion of the cavity block.

18. The method according to claim 11, wherein the molding die cleaning sheets each have a size able to cover the whole of the molding die.

19. The method according to claim 11, wherein the molding die cleaning sheets each have such a thickness as prevents leakage of the cleaning resin from the sheets.

20. The method according to claim 11, wherein the molding die cleaning sheets are each thinner than the mask sheet.

21. The method according to claim 11, wherein the weight of each of the molding die cleaning sheets and the weight per unit area thereof are not more than 55 g/cm².

22. A method of manufacturing a semiconductor device, comprising the steps of:
(a) providing a rubbery cleaning sheet, first and second molding die cleaning sheets permitting impregnation and penetration of the rubbery cleaning resin, and a mask substrate easily releasable from the rubbery cleaning resin;
(b) disposing the mask substrate so as to close suction holes formed in a surface of a lower mold of a molding die, the molding die comprising a pair of an upper mold and the lower mold;
(c) disposing the first molding die cleaning sheet over the mask substrate and between the upper mold and the lower mold so as to include a cavity portion of the molding die and a pot portion positioned adjacent the cavity portion;
(d) disposing the rubbery cleaning resin over the first molding die cleaning sheet and between the upper mold and the lower mold so as to include the cavity portion of the molding die and the pot portion positioned adjacent the cavity portion;
(e) disposing the second molding die cleaning sheet over the rubbery cleaning resin and between the upper mold and the lower mold so as to include the cavity portion of the molding die and the pot portion positioned adjacent the cavity portions;
(f) after the step (e), filling the cavity portion of the molding die, a stepped portion adjacent the cavity portion and the pot portion with the rubbery cleaning resin by a clamping pressure of the molding die; and
(g) after the step (f), taking out the rubbery cleaning resin, the first molding die cleaning sheet, the second molding die cleaning sheet and the mask substrate from the molding die,
wherein, after the step (f), the rubbery cleaning resin, the first molding die cleaning sheet and the second molding die cleaning sheet are formed integrally.

23. The method according to claim 22, further comprising the steps of:
(h) after the step (g), disposing the mask substrate so as to close the suction holes formed in the surface of the lower mold;
(i) after the step (h), disposing a third molding die cleaning sheet over the mask substrate and between the upper mold and the lower mold so as to include the cavity portion of the molding die (and the pot portion positioned adjacent the cavity portion); and
(j) disposing a tableted cleaning resin in the pot portion and filling the cavity portion with the cleaning resin from the pot portion.

24. The method according to claim 22, further comprising, after the step (g), the step of disposing a package substrate over the lower mold and forming a sealing body with use of sealing resin.

25. The method according to claim 22, wherein the amount of the rubbery cleaning resin filled into the stepped portion is smaller than that of the rubbery cleaning resin filled into the cavity portion.

26. The method according to claim 22, wherein in the step (f) pressure and heat are applied almost simultaneously with the clamping of the molding die.
